(19) United States
(12) Patent Application Publication
(10) Pub. No.: US 2007/0104957 A1
(43) Pub. Date: May 10, 2007

(54) Method of forming a radiation curable coating and coated article

(75) Inventor: Wojciech A. Wilczak, Jersey City, NJ (US)

Correspondence Address: DICKSTEIN SHAPIRO, 1177 AVENUE OF THE AMERICAS (6TH AVENUE), NEW YORK, NY, 10036-2714, US

(73) Assignee: Sun Chemical Corporation, Parsippany, NJ (US)

(21) Appl. No.: 10/583,328

(22) PCT Filed: Dec. 16, 2004
(86) PCT No.: PCT/US04/42114

§ 371 Date: Dec. 5, 2006

Related U.S. Application Data
(60) Provisional application No. 60/529,832, filed on Dec. 16, 2003.

(51) Int. Cl. B05D 7/00; B32B 27/20; B32B 27/38; B32B 27/30

(52) U.S. Cl. 428/413; 427/487; 427/407.1; 428/420; 428/522

(57) ABSTRACT

A plasma polymer having residual functional (reactive) groups is formed on a substrate, a radiation curable coating composition is applied to the plasma polymer-coated substrate, and the radiation curable composition is radiation cured. The radiation curable composition contains a component which forms a polymer with the reactive groups of the plasma polymer, anchoring the cured composition to the plasma polymer which is anchored to the substrate.

This disclosure is entitled to the priority of U.S. Provisional Application Ser. No. 60/529,382, filed Dec. 16, 2003.

### BACKGROUND OF THE INVENTION

The present invention relates to a method for forming a radiation curable coating on a substrate, which has particular utility in forming a ultraviolet (UV) or electron beam (EB) ink coating on a substrate, and to the resulting coated article.

Radiation curable coatings, including inks, have been developed for a variety of applications. Broadly considered, the coating compositions contain a radiation curable monomer or prepolymer, together with viscosity controllers, antioxidants, polymerization inhibitors, polymerization catalysts, surfactants, etc. as appropriate to obtain desired characteristics. One problem encountered with such systems is the adhesion to the substrate being coated and various systems to improve adhesion have been developed. While achieving better adhesion, those systems can also introduce new problems. New approaches to the adhesion problem are desired.

Also, substrates have be coated for a variety of other reasons, for example to protect the substrate from corrosion, to provide a barrier to oxidation, to improve adhesion with other materials, to increase surface activity, and for reasons of biomedical compatibility of the substrate. A variety of systems have been developed and are available for this purpose.

In some methods for modifying or coating the surface of a substrate, the surface is subjected to a plasma discharge. Plasma deposition techniques have thus been quite widely used for the deposition of polymeric coatings onto a range of surfaces. It is a clean, dry technique that generates little waste compared to conventional wet chemical methods. In this method, plasmas are generated from, inter alia, small organic molecules, which are subjected to an ionising electrical field under low pressure conditions. When this is done in the presence of a substrate, the ions, radicals and excited molecules of the compound in the plasma polymerize in the gas phase and react with a growing polymer film on the substrate. Conventional polymer synthesis tends to produce structures containing repeat units which bear a strong resemblance to the monomer species, whereas a polymer network generated using a plasma can be extremely complex.

Examples of this technique include U.S. Pat. No. 5,876,753 which discloses a process for attaching materials to a solid surface which process includes affixing carbonaceous compounds to a surface by low power variable duty cycle pulsed plasma deposition; and EP 0896035 discloses a coating process in which the coating is applied to the substrate by plasma polymerization of an organic compound or monomer-containing gas. DE 19924108 describes a process for coating dyestuffs and corrosion inhibitors onto substrates by application of a liquid film coating onto a substrate and then establishing a plasma polymer protective coating. The combination of plasma activation and solution phase grafting of a polymerizable epoxy monomer on a substrate (Mori, M. et al., J. Polym. Sci., Part A: Polym. Chem., 1994, 32, 1683; Yamada, K. et al., J. Appl. Polym. Sci., 1996, 60, 1847) is also known. These approaches are designed to realize a coating on the substrate, in the form of the final desired coating or as an adhesive, etc.

### SUMMARY OF THE INVENTION

It has now been discovered that it is possible to modify a known method which has been used heretofor for the purpose of forming a coating on a substrate in such a way that the resulting modified coated surface will effectively anchor a radiation curable coating composition, particularly a UV or EB cured ink. In accordance with the present invention, a plasma polymer having residual functional (reactive) groups is formed on a substrate, a radiation curable coating composition is applied to the plasma polymer-coated substrate, and the radiation curable composition is radiation cured. The radiation curable composition contains a component which forms a polymer with the reactive groups of the plasma polymer, anchoring the cured composition to the plasma polymer which is anchored to the substrate.

### DESCRIPTION OF THE INVENTION

A plasma polymer having residual functional (reactive) groups is formed on a substrate in the present invention, followed by applying a radiation curable coating composition to the plasma polymer-coated substrate, and radiation curing the radiation curable composition.

The substrate can be any solid substrate, such as fabric, metal, glass, ceramics, paper, wood, woven or non-woven fibres, natural fibres, synthetic fibres, cellulose materials, siloxanes, and polymers such as polytetrafluoroethylene, polythene or polystyrene. The size of the substrate is limited only by the dimensions of the plasma treating apparatus used.

Any known method of forming a plasma polymer on the surface of the substrate can be employed if modified to realize a polymer having residual reactive groups. For instance, the procedures described in WO 00/78469 or WO 02/28548, the disclosures of which are hereby incorporated by reference, can be used if so modified, but other plasma polymer forming methods can also be employed as disclosed, for example, in U.S. Pat No. 6,551,950, and US patent publications 20030104140 and 20020114954 and other publications.

Briefly, the procedure described in WO 00/78469 involves subjecting the substrate to a plasma discharge in the presence of an epoxide of the formula R¹C(O)YR²−R³ or R¹C₆H_{4R}³ in which R¹ is an optionally substituted alkyl, alkenyl, alkynyl, aryl or aralkyl group, R² is an optionally substituted alkylene chain and R³ is an epoxide group. Glycidyl (meth)acrylates can be used as the epoxide.

The plasma deposition conditions vary depending upon factors such as the nature of the monomer, the substrate etc. and will be determined using routine methods. In general, polymerization subjects an epoxide gas to pressures of from 0.01 to 10 mbar, and a glow discharge is then ignited by applying a high frequency voltage, for example at 13.56 MHz. The applied fields, pulsed or continuous, are suitably of average power of up to 50 W for 30 seconds to 20 minutes, and when pulsed, are low, for example of less than 0.05 W/cm³.

Suitable plasmas include non-equilibrium plasmas such as those generated by radiofrequencies (Rf), microwaves or direct current (DC). They may operate at atmospheric or sub-atmospheric pressures as is known in the art. The plasma may be the monomeric compound alone or in admixture with for example an inert gas. The temperature in the plasma chamber is suitably high enough to allow sufficient monomer in gaseous phase to enter the plasma chamber.

The procedure described in WO 02/28548 involves using a combination of an atmospheric pressure plasma discharge and an atomized liquid and/or solid coating forming material. The atomized liquid and/or solid coating-forming material is introduced into an atmospheric pressure plasma discharge and/or an ionized gas stream resulting therefrom, and the substrate is exposed to the atomized coating-forming material. Any conventional means for generating an atmospheric pressure plasma glow discharge may be used, such as atmospheric pressure plasma jet, atmospheric pressure microwave glow discharge and atmospheric pressure glow discharge. Typically, such means will employ a helium diluents and a high frequency (e.g.>1 kHz) power supply to generate a homogeneous glow discharge at atmospheric pressure via a Penning ionization mechanism. The coating-forming material may be atomized using any conventional means, for example an ultrasonic nozzle. The atomizer preferably produces a coating-forming material drop size of from 10 to 100 μm. Suitable coating forming materials include carboxylates, methacrylates, acrylates, styrenes, methacrylonitriles, alkenes and dienes, for example methyl methacrylate, ethyl methacrylate, propyl methacrylate, butyl methacrylate, and other alkyl methacrylates, and the corresponding acrylates, including organofunctional methacrylates and acrylates, including glycidyl methacrylate, trimethoxysilyl propyl methacrylate, allyl methacrylate, hydroxyethyl methacrylate, hydroxypropyl methacrylate, dialkylaminoalkyl methacrylates, and fluoroalkyl (meth) acrylates, methacrylic acid, acrylic acid, fumaric acid and esters, itaconic acid (and esters), maleic anhydride, styrene, α-methylstyrene, halogenated alkenes, for example, vinyl halides, such as vinyl chlorides and vinyl fluorides, and fluorinated alkenes, for example perfluoroalkenes, acrylonitrile, methacrylonitrile, ethylene, propylene, allyl amine, vinylidene halides, butadienes, acrylamide, such as N-isopropylacrylamide, methacrylamide, epoxy compounds, for example glycidoxypropy-trimethoxysilane, glycidol, styrene oxide, butadiene monoxide, ethyleneglycol diglycidylether, glycidyl methacrylate, bisphenol A diglycidylether (and its oligomers), vinylcyclohexene oxide, conducting polymers such as pyrrole and thiophene and their derivatives, and phosphorus-containing compounds, for example dimethylallylphosphonate. Organometallic compounds may also be suitable coating-forming materials, including metal alkoxides such as titanates, tin alkoxides, zirconates and alkoxides of germanium and erbium.

The plasma coating conditions of the prior art processes are modified such that the resulting plasma polymers contain residual reactive groups. This can be accomplished by adjusting the reaction conditions, e.g., time, temperature, concentrations, pressure, etc., so that the polymerizable groups are not fully consumed during the polymerization process. In some prior art processes, the presence of unreacted groups was viewed as a deficiency to be overcome but in the present invention, the presence of those groups is deliberate. The quantity of unreacted groups is not critical as long as they are sufficient to anchor the subsequently applied radiation curable composition. In the present invention, the plasma polymer is preferably a (meth)acrylate, i.e., an acrylate or methacrylate, such as for instance TMPTA (trimethylolpropane triacrylate).

While not preferred, the presence of reactive groups can be achieved by derivatizing the plasma polymer. For instance, epoxy groups may be reacted with a carboxylic acid such as trifluoroacetic acid, an amine such as diethylamine or an amino acid.

A radiation curable coating composition is applied to the plasma polymer coated surface or to selected portions of the surface, and then radiation cured. Any radiation curable coating composition can be used as long as a component forms a polymer which includes a reaction product with the reactive groups of the plasma polymer, thereby linking the radiation cured material to the substrate surface. Thus, any known radiation curable coating composition can be used.

The radiation curable composition is preferably a radiation curable ink which contains a colorant composition and a radiation curable liquid vehicle substantially free of a fugitive solvent. The term “substantially free of fugitive solvent” as used herein in reference to inks, means free of a liquid component (e.g., water, lower alcohols, alkanes, aromatics, aliphatics, ketones, acetates and the like) which, after printing, is evaporated, imbibed into a substrate surface, or both, and does not remain as an essential component of the cured ink, but is not intended to exclude trace or residual solvents resulting from the manufacture of ink components prior to ink formulation.

The radiation curable liquid vehicle is employed in an amount sufficient to make up 100% of the ink weight when taken together with other ink components. The radiation curable liquid vehicle typically comprises one or more low molecular weight mono-functional or multi-functional monomers. For offset inks and other inks which require higher viscosities, a resin, a reactive oligomer or polymer may also be present. These components may react with the monomers upon curing. The energy curable liquid vehicle is characterized in that it is curable to a solid by exposure to energy from a radiant energy source, such as exposure to high energy electrons from an electron beam source. Alternatively, curing of the liquid vehicle may be initiated by energy activation of a polymerization initiating system (e.g. by UV radiation). In this context, a polymerization initiating system may be considered an optional component of the energy curable liquid vehicle. The liquid vehicle may be a ring opening polymerizable composition, a free radical addition polymerizable composition, or by a combination of ring opening and free radical polymerization. In these compositions, the liquid vehicle is cured or hardened by polymerizing and/or crosslinking, at least the reactive monomers of the liquid vehicle. In order to reduce environmental contamination and maintain formulation integrity, the liquid vehicle is typically formulated with components having low volatility under ambient printing conditions.

The monomers typically contains at least one alpha, beta-ethylenically unsaturated, radiation polymerizable group. Suitable monomers include, but are not limited to an epoxy acrylate, an epoxy methacrylate, a polyether acrylate, a polyether methacrylate, a polyester acrylate, a polyester methacrylate, a polyurethane acrylate, a polyurethane methacrylate, a melamine acrylate, or a melamine methacrylate. Typically, the acrylate is an aromatic or aliphatic acrylate or methacrylate and preferably, the compound is a diacrylate ester of an alkanol glycidyl ether such as 1,4-butanedioldiglycidyl ether, an ethoxylated aromatic epoxide and ethoxylated trimethylolpropane triacrylate, ethoxylated trimethylolpropane trimethacrylate, ethoxylated aliphatic or aromatic epoxy acrylate, ethoxylated aliphatic or aromatic epoxy methacrylate, polyoxyethylene glycol diacrylate; and polyoxyethyleneglycol di-methacrylate.

The radiation curable composition may contain from 0 to about 50 wt. % of a colorant such as a dye or pigment. Preferably, such dyes or pigments, while soluble or dispersible in the curable composition, form permanent non-migratory components in the cured composition. When used as a radiation curable ink, the coating solution typically contains one or more solid pigments dispersed therein. The pigment may be any conventional organic or inorganic pigment such as zinc sulfide, Pigment White 6, Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57, Pigment Red 112, Pigment Red 122, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 19, Pigment Violet 23, Pigment Black 7 and the like. The colorant may also be selected from a dye or pigment certified for use by the Federal Food Drug and Cosmetics Act and include FD&C Red No. 3, D&C Red No. 6, D&C Red No. 7, D&C Red No. 9, D&C Red No. 19, D&C Red No. 21, D&C Red No. 22, D&C Red No. 27, D&C Red No. 28, D&C Red No. 30, D&C Red No. 33, D&C Red No. 34, D&C Red No. 36, FD&C Red No. 40, D&C Orange No. 5, FD&C Yellow No. 5, D&C Yellow No. 6, D&C Yellow No. 10, FD & C Blue No. 1, Iron Oxide Yellow, Iron Oxide Brown, Iron Oxide Red, Iron Oxide Black, Ferric Ammonium Ferrocyanide, Manganese Violet, Ultramarine Blue, Chrome Oxide Green, Hydrated Chrome Oxide Green, and Titanium Dioxide. Pigment compositions which are also useful in the energy curable inks of this invention are described in U.S. Pat. Nos. 4,946,508; 4,946,509; 5,024,894; and 5,062,894, each of which is incorporated herein by reference. Such pigment compositions are a blend of the pigment along with a poly(alkylene oxide) grafted pigment. Aqueous curable compositions containing a colorant are particularly useful in formulating radiation curable printing inks for use in conventional printing such as flexographic, gravure letterpress dry-offset and lithographic printing. Although each of these printing operations require printing inks with specific characteristics such as specific viscosity ranges, such characteristics can be realized by adjusting the ratio of solids including the pigment.

The curable compositions may contain additional adjuvants provided that the additional adjuvants do not materially affect the essential nature of the composition and that the adjuvants or their residue after polymerization, are non-migratory and are substantially not leachable from the cured film. Thus, the radiation curable compositions and inks of this invention may contain the typical adjuvants to adjust flow, surface tension and gloss of the cured coating or printed ink. Such adjuvants contained in inks or coatings typically are a surface active agent, a wax, fillers, matting agents, or a combination thereof. These adjuvants may function as leveling agents, wetting agents, dispersants, defrothers or deareators, or additional adjuvants may be added to provide a specific function. Preferred adjuvants include fluorocarbon surfactants such as FC-430, a product of the 3M company; silicones, such as DC57, a product of Dow Chemical Corporation; polyethylene wax; polyamide wax; paraffin wax; polytetrafluoroethylene wax; and the like.

The coating compositions may also contain from about 0 to about 50 wt. %, preferably from about 1 to 50 wt. %, of a filler. Examples of suitable fillers are silicates obtainable by hydrolyzing silicon tetrachloride (commercially available as Aerosil from Degussa), siliceous earth, talc, aluminum silicates, sodium aluminum silicates magnesium silicates, etc. The coating compositions may also include from 0 to 20 wt. % of protective colloids and/or emulsifiers. Suitable emulsifiers are those commonly employed as dispersants in the context of aqueous emulsion polymerization and known to the skilled worker, such as those described in Houben-Weyl, Methoden der Organischen Chemie, Volume XIV/1, Makromoleculare Stoffe, Georg-Thieme-verlag, Stuttgart, 1961, pp. 411-420. Suitable protective materials include polyvinyl alcohol, polyvinylpyrrolidone, cellulose, cellulose derivatives, starch, starch derivatives, gelatin, gelatin derivatives, etc.

The curable composition may be applied to the substrate surface using any conventional coating technique. Thus, the composition may be spin coated, bar coated, roller coated, curtain coated or may be applied by brushing, spraying, etc. Alternatively, the aqueous composition may be applied imagewise to the substrate surface, for instance as a printing ink, using any conventional printing technique.

The applied composition is cured using either high energy electrons or UV radiation. Typically, the high energy electrons have an energy between 50 and 200 kV electrons and preferably between 85 and 180 kV electrons and are typically produced by high energy electron device. The dosage of high energy electron ranges from about 2 to about 4 megarads (Mrads); and preferably from 2.7 to 3.5 Mrads. UV irradiation may be carried out using any conventional off-contact exposure device which emits within the spectral region from about 200 to about 420 nanometers.

The following examples are set forth to further illustrate aspects of the invention without intending to limit it. Throughout this disclosure, all parts and percentages are by weight and all temperatures in degrees Centigrade unless otherwise indicated.

### EXAMPLE 1

### Plasma Polymer Coating

A piece of polyethylene film substrate is ultrasonically washed in a 1:1 mixture of isopropyl alcohol and cyclohexane and placed on a glass plate in a chamber. After evacuation of residual gas, a plasma discharge gas is introduced at a flow rate of 1900 sccm and a pressure of 1.02×10⁵Nm⁻². Two discharge gasses are used, helium and a 99% helium/1% oxygen mixture. After 10 minutes of purging, a syringe pump is switched on and the coating-forming material allowed to flow at a rate of3×10⁻⁵ m1s−1″. Two coating-forming materials are used, octamethyl-cyclotetrasiloxane and tetramethyl-cyclotetrasiloxane. When the coating-forming material reaches an ultrasonic nozzle, the ultrasonic generator is switched on (2.5 W) to initiate atomization of the coating-forming material, and the atmospheric pressure plasma discharge is ignited by applying 1.5 kV across the electrodes.

Deposition of the coating-forming material is allowed to proceed for 10 minutes, following which the substrate is removed and placed under vacuum for 20 minutes to remove any labile material.

### EXAMPLE 2

### Use Of Red Radiation Curable Printing Ink

Forty parts of a red colorant aqueous dispersion (Sunsperse RHD6012 from Sun Chemical Pigments Division), 50 parts of an aliphatic epoxy acrylate (Laromer LR8765 from BASF), 5 parts of water, 5 parts of a photoinitiator (Irgacure 2959 from Ciba) are mixed together. It is applied to the plasma polymer coated substrate with a flexo hand proofer and cured by UV radiation.

### EXAMPLE 3

### Use Of Blue Radiation Curable Printing Ink

Thirty parts of pigment blue 15:3 (Phthalocyanine blue from Sun Chemical) and 70 parts of a highly ethoxylated trimethylolpropane triacrylate (15 mole EO, SR9035 from Sartomer) are ground on a three roll mill to form a concentrated base with a grind of 2/0. Twenty parts of the base are mixed with 40 parts of a polyethylene glycol (400) diacrylate (SR 344 from Sartomer), 10 parts of a photoinitiator (Irgacure 2959 from Ciba), 10 parts of highly ethoxylated trimethylolpropane triacrylate (15 mole EO, SR9035 from Sartomer) and 40 parts of water to form a blue ink. The ink is applied to the plasma polymer coated substrate of Example 1 with a flexo hand proofer and cured by UV radiation.

### EXAMPLE 4

### Use Of An Energy Curable, Cationic Ink

A Theological additive is prepared by charging a presscake containing 210 parts by weight of copper phthalocyanine sulfonyl chloride (prepared by any conventional method) into a mixture of 692 parts by weight of a primary amine-terminated poly(ethylene oxide/propylene oxide) (5/95) copolymer having a number average molecular weight of approximately 2,000 (available as XTJ 507 from the Huntsman Corporation) and 66 parts by weight of sodium carbonate and mixed. The final reaction mixture is then heated to 80-90° C. under vacuum to remove water and produce the copper phthalocyanine additive.

A modified Pigment Blue 15.4 composition is prepared by combining 12% by weight of the copper phthalocyanine derived rheological additive with 79% by weight of conventional Pigment Blue 15.4 during the attrition process step of the conventional pigment.

The energy curable, cationic ink was formulated from the following components.

| COMPONENTS | WEIGHT % |
|---|---|
| Cyracure 6110 | 15 |
| Modified Pigment Blue 15.4 | 5 |
| CD 1012 | 2 |
| Irgacure 261 | .5 |
| DVE 3 | 76 |
| PE wax | 1 |
| DC 57 | .5 |

Irgacure 26 is (n⁵ -2,4-cyclopentadien-1-yl) [(1,2,3,4,5,6-N) (1-methyl ethyl)benzene I-iron-hexafluorophosphate; and DVE is triethyleneglycol divinyl ether. The Cyracure 6110 and the modified Pigment Blue 15.4 are mixed at high speed (about 2000 rpm) with a Cowles blade and then processed through a media mill containing 1 mm size media. After processing, the remaining components are added.

Printing runs are carried out on plasma polymer coated substrate of Example 1 with a gravure hand-proofer from Pamarco Inc. The major elements of the gravure hand-proofer are: a 300 line/inch (118 line/cm) anilox roller; and a doctor blade assembly for regulating the ink supplied to the anilox roller. The printed samples are passed through a UV curing unit from R.P.G. Industries having a lamp with an output of 400 Watts/inch in the UV spectral region and a cylindrical reflector. The printing speed is about 1 m/sec (200 ft./min.) Using the modified Pigment Blue 15.4 ink composition, a uniform ink film was applied to the substrate with the hand proofer and cured with this curing unit.

Various changes and modification can be made in the process and products of this invention without departing from the spirit and scope thereof. The various embodiments set forth in this description were intended to further illustrate the invention and not to limit it.

What is claimed is:

1. A method of forming a coated substrate which comprises providing a plasma polymer coating containing residual unpolymerized polymerizable functional groups on a substrate, applying a radiation curable composition to the plasma polymer-coated substrate, wherein the radiation curable composition comprises at least one component with forms a reaction product with the residual unpolymerized polymerizable functional groups when radiation is applied, and radiation curing the radiation curable composition.

2. A method of forming a coated substrate according to claim 1, wherein the radiation curable composition is a radiation curable gravure ink.

3. A method of forming a coated substrate according to claim 1, wherein the radiation curable composition is a radiation curable flexographic ink.

4. A method of forming a coated substrate according to claim 1, wherein the radiation curable composition is a radiation curable lithographic ink.

5. A method of forming a coated substrate according to claim 1, wherein the radiation curable composition is a radiation curable ink comprising a colorant composition and a radiation curable liquid vehicle.

6. A method of forming a coated substrate according to claim 1, wherein the radiation curable vehicle comprises an alpha, beta-ethylenically unsaturated compound.

7. A method of forming a coated substrate according to claim 6, wherein the alpha, beta-ethylenically unsaturated compound comprises a (meth)acrylate.

8. A method of forming a coated substrate according to claim 1, wherein the plasma polymer coating comprises a polymerized epoxide or (meth)acrylate.

9. A method of forming a coated substrate according to claim 1, further comprising forming said plasma polymer coating.

10. A method of forming a coated substrate according to claim 1, wherein said curing is electron beam curing.

11. A method of forming a coated substrate according to claim 1, wherein said curing is UV curing.

12. A coated substrate comprising a substrate having a plasma polymer coating thereon and a radiation cured composition on the plasma polymer-coated substrate, wherein a portion of the plasma polymer and a portion of the radiation cured composition have formed a reaction product.

13. A coated substrate according to claim 12, wherein radiation cured composition is a radiation cured gravure ink.

14. A coated substrate according to claim 12, wherein the radiation cured composition is a radiation cured flexographic ink.

15. A coated substrate according to claim 12, wherein the radiation cured composition is a radiation cured lithographic ink.

16. A coated substrate according to claim 12, wherein the radiation cured composition is a radiation curled ink comprising a colorant and a radiation cured liquid vehicle.

17. A coated substrate according to claim 16, wherein the vehicle comprises a polymerized (meth)acrylate.

18. A coated substrate according to claim 1, wherein the plasma polymer coating comprises a polymerized epoxide or (meth)acrylate.

19. A coated substrate according to claim 18, wherein the radiation cured composition is a radiation curled ink comprising a colorant and a radiation cured liquid vehicle.

20. A coated substrate according to claim 19, wherein the vehicle comprises a polymerized (meth)acrylate.
